(19) United States
(12) Patent Application Publication
(10) Pub. No.: US 2016/0111804 A1
(43) Pub. Date: Apr. 21, 2016

(54) Connector

(71) Applicant: IRISO ELECTRONICS CO., LTD., Kanagawa (JP)

(72) Inventors: Tomomitsu Saito, Kanagawa (JP); Takanori Kimata, Kanagawa (JP); Yoshiyuki Ogura, Kanagawa (JP)

(73) Assignee: IRISO ELECTRONICS CO., LTD., Kanagawa (JP)

(21) Appl. No.: 14/881,501

(22) Filed: Oct. 13, 2015

(30) Foreign Application Priority Data
Oct. 15, 2014 (JP) 2014-210579

(51) Int. Cl. H01R 13/42; H01R 4/48

(52) U.S. Cl. CPC H01R 13/42; H01R 4/48

(57) ABSTRACT

A terminal of a connector includes a contact section that comes into contact with a pin terminal of a counterpart connector and a movable spring section that elastically supports the contact section to be displaceable in a direction which intersects with an axis of the pin terminal in a fitting chamber of a housing. Further, the connector includes a clip terminal which is displaceable following the displacement of the contact section while holding the pin terminal that is in contact with the contact section in the fitting chamber.

### BACKGROUND OF THE INVENTION

1. Field of the Invention

The present invention relates to a connector that is configured to be in conductive contact with a pin terminal of a counterpart connector which is a connection target member.

2. Description of the Related Art

A known connector has a floating mechanism that absorbs positional deviation during connection or displacement after connection of a connection target member (see Japanese Unexamined Patent Application Publication No. 2007-18785). The connector generally includes a fixed housing which is mounted on a substrate, a movable housing which is fitted with a counterpart connector, and a terminal having a movable piece which is fixed to the fixed housing and the movable housing to connect the both. Such a connector is advantageous in that the floating mechanism can absorb positional deviation or displacement. However, since the connector includes the fixed housing and the movable housing, the entire size of the connector is larger than that of the connector which does not include a floating mechanism. There is a substantial need of decreasing the size of the connector to effectively use a limited surface area of the circuit board and the space around the circuit board.

### SUMMARY OF THE INVENTION

Accordingly, it is an object of the present invention to reduce size of a connector which includes a floating mechanism that absorbs positional deviation during connection or displacement after connection of a connection target member.

The present invention is provided as described below in order to achieve the above object.

According to an aspect of the present invention, a connector includes a terminal that is configured to be in conductive contact with a pin terminal of a connection target; a housing which includes a fitting chamber that is configured to be in conductive contact with the pin terminal and the terminal, the terminal including a contact section that comes into contact with the pin terminal and a movable spring section that elastically supports the contact section to be displaceable in the fitting chamber; and a clip terminal which is displaceable following the displacement of the contact section while holding the pin terminal that is in contact with the contact section in the fitting chamber.

The present invention proposes a connector which includes a terminal having a novel floating mechanism that does not need a plurality of housings such as a fixed housing and a movable housing of a conventional connector. That is, the terminal of the connector according to the present invention includes the contact section that comes into contact with the pin terminal of the connection target, and the movable spring section that elastically supports the contact section to be displaceable in the fitting chamber. That is, since the contact section is displaced in the fitting chamber, positional deviation during connection or displacement after connection of the pin terminal can be absorbed. Accordingly, the floating mechanism of the terminal according to the present invention can reduce the size of the conventional connector which includes a floating mechanism that displaces the fixed housing and the movable housing relative to each other.

Further, the connector according to the present invention includes the clip terminal which is displaceable following the displacement of the contact section while holding the pin terminal that is in contact with the contact section in the fitting chamber. With this configuration, since the clip terminal directly or indirectly hold the pin terminal which is in contact with the contact section, conductive contact of the contact section can be reliably maintained, thereby improving connection reliability. Further, the clip terminal can be displaced without disturbing the displacement of the contact section which moves along with positional deviation during connection or displacement after connection of the pin terminal while clipping (holding) the pin terminal.

According to the above aspect of the present invention, the connector may include a plurality of the terminals, wherein the contact sections of the terminals are independently displaceable while being elastically supported by the movable spring section.

With this configuration, since the contact sections of the terminals are independently elastically supported by the movable spring section and may be or may not be individually displaced. Accordingly, they may be displaced as needed for each of the terminals. Further, even if the connector includes a plurality of terminals which are displaceable, there is no need of providing a movable housing for each of the terminals since they are individually displaced for each of the terminals, thereby reducing the entire size of the connector.

According to the above aspect of the present invention, the movable spring section may be flexibly deformed so that the contact section is displaced in a direction which intersects with an axis of the pin terminal. Further, the movable spring section may be flexibly deformed so that the contact section is displaced in an axis direction of the pin terminal.

With this configuration, the contact section is displaced in the direction which intersects with the axis of the pin terminal or the axis direction of the pin terminal. That is, the contact section may be displaced in the three dimensional directions or at least one of the three dimensional directions so as to effectively absorb positional deviation during connection or displacement after connection of the pin terminal.

According to the above aspect of the present invention, the clip terminal may include a fixing section fixed to the housing, a clip section that holds the pin terminal, and a movable supporting section that supports the clip section to the fixing section to be elastically displaceable in the fitting chamber while connecting the fixing section and the clip section.

With this configuration, the movable supporting section supports the clip section to be elastically displaceable in the fitting chamber. Accordingly, the clip section of the clip terminal can be displaced following the displacement of the contact section which moves along with positional deviation during connection or displacement after connection of the pin terminal while clipping the pin terminal.

In the connector having a conventional floating structure, a movable piece of the terminal absorbs the displacement of the movable housing (counterpart connector) relative to the fixed housing. Accordingly, the movable housing (and the contact section of the terminal) and the housing of the counterpart connector (and the contact section of the counterpart terminal) are strongly connected to each other so as not to be disconnected. On the other hand, the connector according to the present invention is configured such that a contact holding force to the pin terminal is not entirely applied by the contact section of the terminal, but is reinforced by the clip terminal. Since the contact holding force is also applied by the clip terminal, various features can be achieved by combination of the contact section and the clip terminal. For example, the terminal and the clip terminal may be made of different materials. When terminals made of different materials separately contribute to electric conductivity and holding ability, a hybrid connector having different excellent functionalities can be achieved. More specifically, the terminal may be made of a metal material having high electric conductivity (corson alloy material), while the clip terminal may be made of a different metal material (stainless material) having high heat resistance. Accordingly, the connector which continuously performs reliable holding force under a high temperature condition while performing high electric conductivity by the terminal.

In the connector according to the present invention, there is no need of separately providing a fixed housing and a movable housing as the conventional floating structure since the terminal has a floating structure. Accordingly, the connector can be reduced in size since the floating structure can be achieved in a single housing. Further, since the clip terminal deforms following the displacement of the contact section of the terminal while clipping the pin terminal of the connection target, the terminal which has the floating structure can maintain the conductive contact with the pin terminal in a reliable manner. Further, when a plurality of terminals are provided, the contact sections of the terminals are elastically supported by the movable spring section and are independently displaceable. Accordingly, displacement can be optimized for each of the terminals, and the connector can be generally reduced in size since the movable housing may not be provided for each of the terminals.

### BRIEF DESCRIPTION OF THE DRAWINGS

FIG. 1 is an external perspective view of a connector and a connection target according to one embodiment.

FIG. 2A is a front view of the connector of FIG. 1, and FIG. 2B is a rear view of the connector of FIG. 1.

FIG. 3A is a top view of the connector of FIG. 1, and FIG. 3B is a bottom view of the connector of FIG. 1.

FIG. 4A is a left side view of the connector of FIG. 1, and FIG. 4B is a right side view of the connector of FIG. 1.

FIG. 5A is a perspective view of a left terminal of the connector of FIG. 1, FIG. 5B is a perspective view of a middle terminal of the connector of FIG. 1, and FIG. 5C is a perspective view of a right terminal of the connector of FIG. 1 as seen from the front side.

FIG. 6 is a cross sectional view of the terminal of FIG. 5A.

FIG. 7A is a perspective view which includes a back-top-right side of a clip terminal of the connector of FIG. 1, FIG. 7B is a left side view, FIG. 7C is a front view, and FIG. 7D is a bottom view of the same.

FIG. 8 is a view which shows a combination of the terminal of FIG. 5A and the clip terminal of FIG. 7.

FIG. 9 is a cross sectional view taken along the line 9 of FIG. 2.

FIG. 10 is a cross sectional view taken along the line 10 of FIG. 2.

FIG. 11 is a cross sectional view taken along the line 11,12 of FIG. 3 before the pin terminal is conductively connected.

FIG. 12 is a cross sectional view taken along the line 11,12 of FIG. 3 after the pin terminal is conductively connected.

### DESCRIPTION OF THE PREFERRED EMBODIMENTS

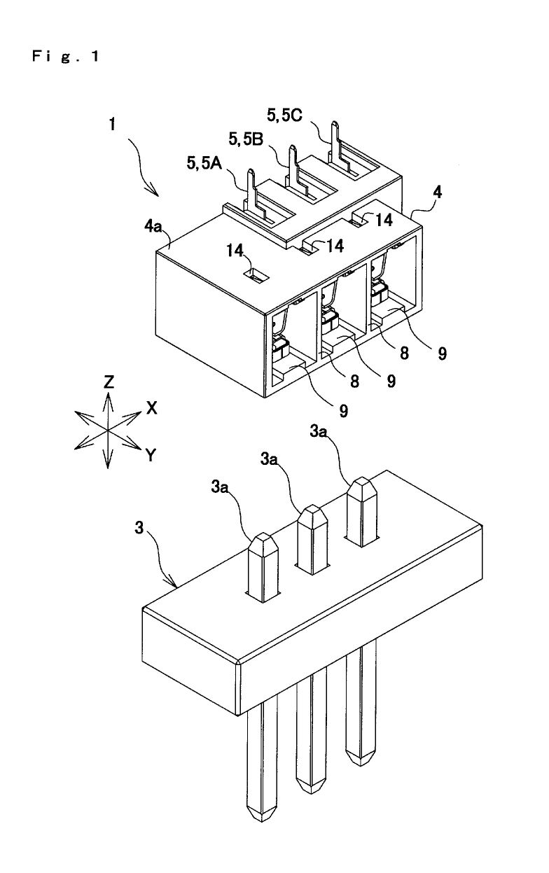

With reference to the drawings, an embodiment of the present invention will be described. In the description of the specification and claims, X direction in FIG. 1 is defined as a width direction (right and left direction), Y direction is defined as a front and back direction, Z direction is defined as an up and down direction (insertion and removal direction) for convenience of explanation. However, those directions are not intended to limit the installation direction or usage direction of a connector 1.

### Description of Connector 1

The connector 1 shown in FIG. 1 is configured to conductively connect a substrate circuit of a printed circuit board 2 on which the connector 1 is mounted and pin terminals 3a of a counterpart connector 3 which is a connection target of the connector 1. The connection target as the counterpart connector 3 may be a variety of connectors. One advantageous example is a hermetic connector. Hermetic connector is configured to hold pin terminals by hermetic seal of glass or the like. This has high air tightness at the holding positions of the pin terminals, but the positional accuracy after seal curing may vary depending on the pin terminals. The connector 1, however, can absorb positional deviation of the pin terminals even if the counterpart connector has such a problem. The connector 1 of this embodiment such as that of this application can absorb positional deviation or displacement of the pin terminals, and the connector 1 may be generally reduced in size since a plurality of housings such as a fixed housing and a movable housing are not necessary unlike the existing floating configuration. The connector 1 includes a housing 4, terminals 5 and clip terminals 6.

### Housing 4

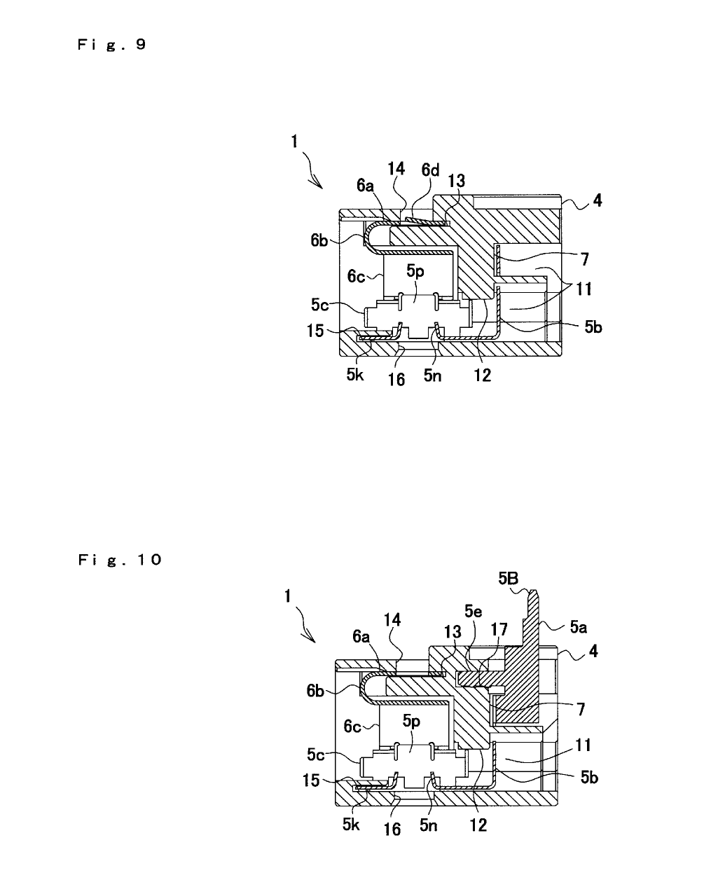

The housing 4 is formed as a box-shaped mold made of a resin having electric isolation property. As shown in FIGS. 9 and 10, a partition wall 7 which extends in the right and left direction X is formed in the housing 4 so as to separate the inner space of the housing 4 into front and back side spaces. Three fitting chambers 9 are formed by two front partition walls 8 on front side of the partition wall 7, and housing recesses 11 of three terminals 5 are formed by two partition walls 10 on back side. Communicating holes 12 that communicate the front-side fitting chambers 9 and the back-side housing recesses 11 are formed under the partition walls 7.

An upper wall 4a of the housing 4 which forms the fitting chamber 7 has a fixing section 13 that fixes a fixing piece 6a of a clip terminal 6, which will be described later. The fixing section 13 has an engaging hole 14 which engages with a lance 6d formed on the fixing piece 6a.

As shown in FIGS. 9 and 10, a socket 15 for a protrusion 5k that protrudes on the lower side of the distal end of a contact section 5c of the terminal 5, which will be described later, is formed on the lower wall 4b of the housing 4 which forms the fitting chamber 7. As the contact section 5c of the terminal 5 is displaced in the right and left direction X or in the front and back direction Y, the protrusion 5k can be displaced until it abuts against the inner wall of the socket 15. Further, insertion holes 16 are formed on the lower wall 4b so that the pin terminals 3a of the counterpart connector 3 are inserted from the outside of the housing 4.

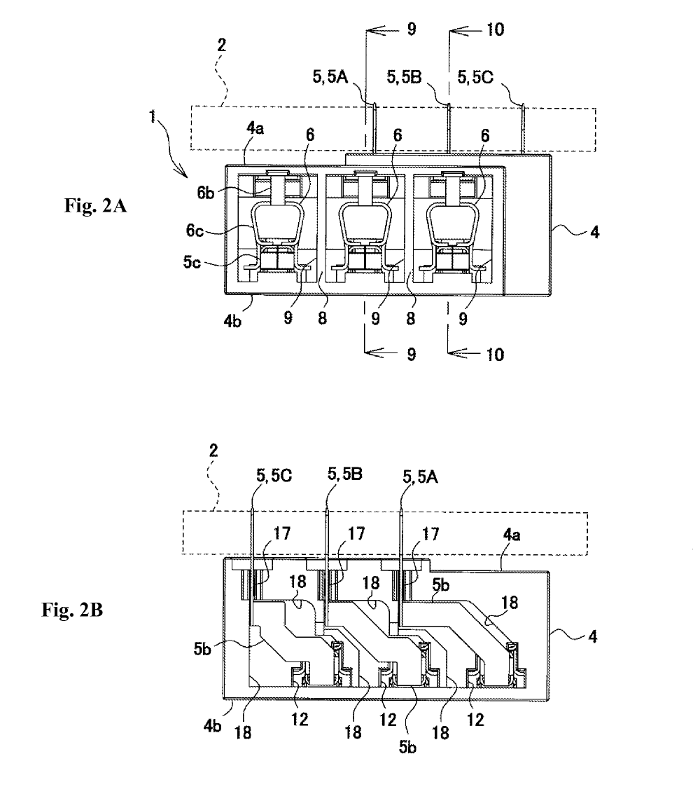

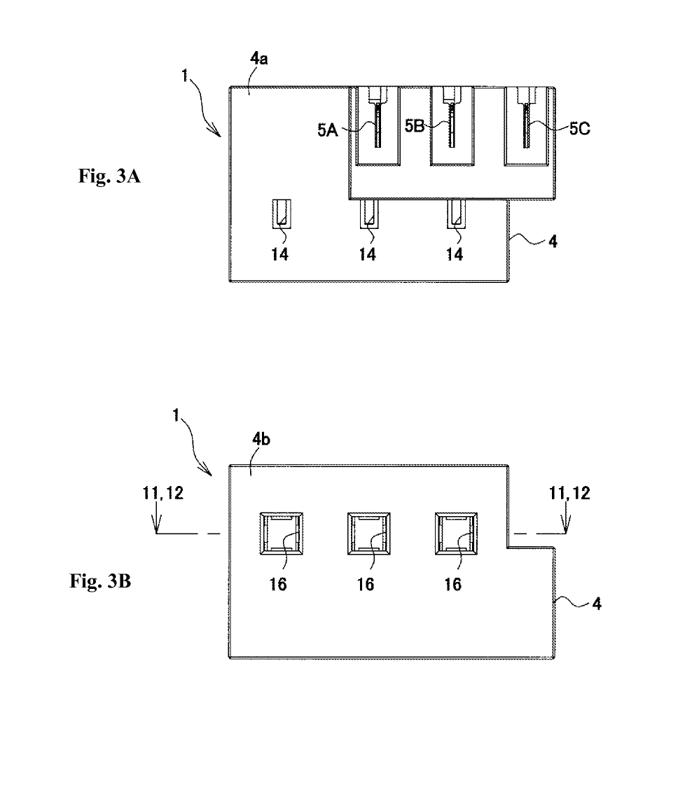

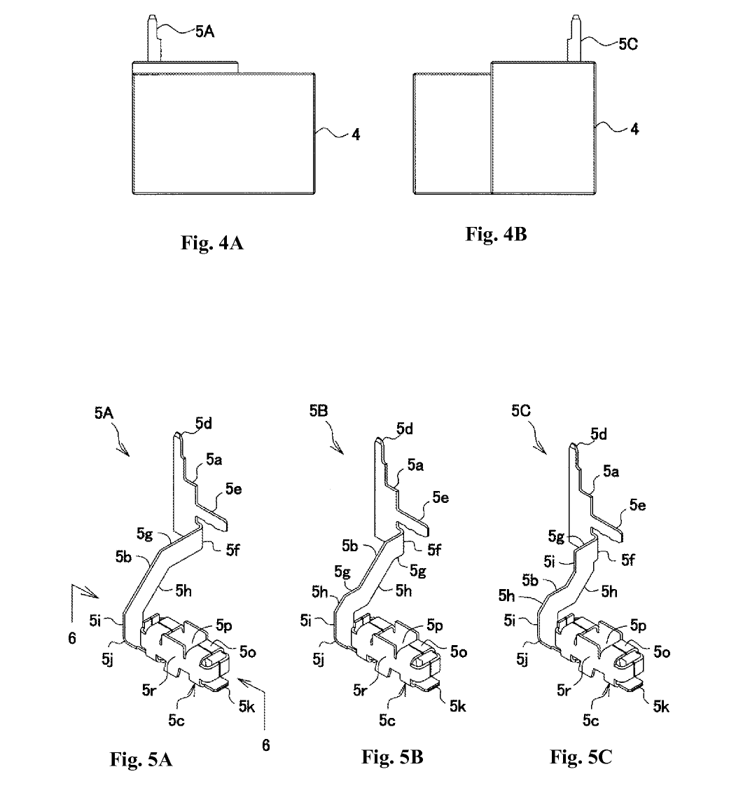

In the housing recess 11 formed on the back surface of the housing 4, a press fitting section 17 for the terminal 5 shown in FIG. 10 and a movable groove 18 shown in FIG. 2B that forms a movable space for the terminal 5 are formed. The terminal 5 is fixed by a press fitting section 17 in the back portion in the housing 4, and the contact section 5c is housed in the fitting chamber 9 in the front portion of the housing 4. The press fitting section 17 is formed offset in the right and left direction X rather than on back side of the fitting chamber 9. The movable groove 18 is formed as a recess which extends in the right and left direction X so as to connect the press fitting section 17 and the fitting chamber 9.

### Terminal 5

The connector 1 includes three terminals 5 (5A, 5B, 5C) as shown in FIG. 5. Each terminal 5 includes a base 5a, a movable spring section 5b, the contact section 5c, which are formed by bending a single metal piece. The terminal 5 may be made of a material such as corson alloy having high electric conductivity.

The base 5a includes a base connection 5d which is inserted into a through hole of the printed circuit board 2 and soldered thereto, and a press fitting piece 5e which is press fitted into the press fitting section 17 of the housing recess 11 of the housing 4 and fixed thereto. The lower side of the press fitting piece 5e is connected to the movable spring section 5b via a fixing side bending portion 5f which is perpendicularly bent in the right and left direction X.

The movable spring section 5b includes a horizontal section 5g which extends in the right and left direction X, an inclined section 5h which extends in an inclined direction, and a vertical section 5i. The lower end of the vertical section 5i is connected to the contact section 5c via a movable side bending section 5j which is perpendicularly bent in the forward direction. Three terminals 5A, 5B, 5C shown in FIGS. 5A to 5C are different in that how the horizontal section 5g, the inclined section 5h and the vertical section 5i which form the movable spring section 5b are combined. Specifically, the terminals 5A, 5B, 5C of FIGS. 5A, 5B, 5C correspond to the terminals 5A, 5B, 5C on the right, middle, left of FIG. 2B, respectively, and the movable spring sections 5b has the lengths which decreases in this order. If they have the same length, the housing 4 increases in size in the right and left direction X. However, the connector 1 is formed in small size by varying the shape of the movable spring section 5b. As shown in the rear side view in FIG. 2B, the adjacent terminals 5 (for example, the terminal 5C and the terminal 5B) are positioned in such a manner that the base 5a (the base 5a of the terminal 5C) and the contact section 5c (the contact section 5c of the terminal 5B) are overlapped in the up and down direction Z, thereby reducing the size of the connector 1 in the right and left direction X.

Those movable spring sections 5b are housed in the movable grooves 18 of the housing 4 as shown in FIG. 2B. They are housed without being in contact with a groove surface of the movable groove 18 so that a degree of freedom of displacement and flexible deformation is ensured for the movable spring sections 5b.

Referring back to FIG. 5, the contact section 5c is formed in a hollow box shape. The protrusion 5k which protrudes forward is formed on the lower side of the distal end of the contact section 5c and is inserted into the socket 15 on the bottom of the fitting chamber 9 of the housing 4 as shown in FIGS. 9 and 10. The protrusion 5k is inserted into the socket 15 in order to prevent the contact section 5c from excessively deforming upward by a force of the pin terminal 3a being inserted into the contact section 5c. Therefore, in order to ensure a normal displacement of the contact section 5c, a gap is provided so as to allow the protrusion 5k to be movable in the right and left direction X, the front and back direction Y and the up and down direction Z in the socket 15. The contact section 5c is held floating in the fitting chamber 9 by the movable spring section 5b so that a portion other than the protrusion 5k is not in contact with the wall surface of the fitting chamber 9.

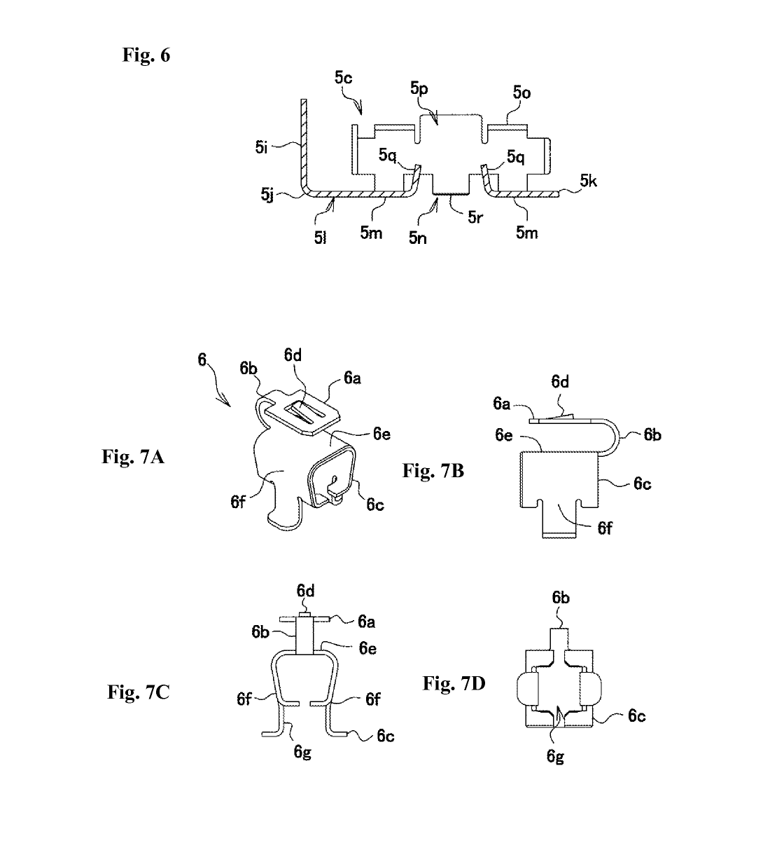

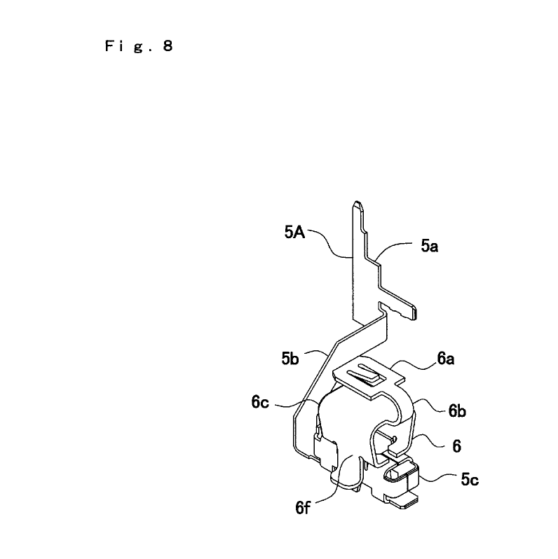

As shown in FIG. 6, a bottom plate 5m and a lower contact hole 5n are formed on a bottom surface 51 of the contact section 5c, and an upper contact hole 5p is formed on a top surface 5o of the contact section 5c. As shown in FIGS. 9 to 12, the pin terminal 3a inserted through the insertion hole 16 of the housing 4 is advanced into the contact section 5c via the lower contact hole 5n and penetrates the contact section 5c via the upper contact hole 5p. Here, the bottom plate 5m is provided with a guide 5q which is bent obliquely upward into the contact section 5c so that the pin terminal 3a is guided by the guide 5q and positioned at a predetermined position in the center of the contact section 5c. The contact section 5c has a side wall 5r so that the side surface of the pin terminal 3a which is inserted as shown in FIG. 12 is held by the side wall 5r.

The above described contact section 5c of the terminal 5 can be displaced in the front and back direction Y due to elastic deformation of the fixing side bending portion 5f which is bent in an obtuse angle more than 90 degrees, deflection of the movable spring section 5b in the thickness direction, and elastic deformation of the perpendicularly bent movable side bending section 5j which is bent in an obtuse angle more than 90 degrees. In addition to the displacement in the front and back direction Y, the contact section 5c can swing in the right and left direction X due to movement of the movable spring section 5b using the fixing side bending portion 5f as a hinge and deflection of the movable spring section 5b in the thickness direction. The displacement of the contact section 5c in the front and back direction Y and the right and left direction X are combined so that the contact section 5c can be displaced in every direction for 360 degrees about an initial position incorporated in the housing 4.

### Clip Terminal 6

As shown in FIG. 7, the clip terminal 6 includes the fixing piece 6a, a movable support section 6b and a clip section 6c, which are formed by bending a single metal plate. The clip terminal 6 may be made of a material different from that of the terminal 5. For example, stainless steel may be used as a material having high holding force suitable for a clip and heat resistance which allows for durability under a high temperature condition.

The fixing piece 6a is formed in a rectangular shape and is inserted into the fixing section 13 of the housing 4 as shown in FIGS. 9 and 10. The lance 6d which engages with the engagement hole 14 of the housing 4 is formed in the center of the fixing piece 6a.

The movable support section 6b that connects the fixing piece 6a and the clip section 6c supports the clip section 6c to be elastically displaceable in the fitting chamber 9. This allows the clip terminal 6 per se to be displaced along with positional deviation during connection or displacement after connection of the pin terminal 3a of the counterpart connector 3.

The clip section 6c includes a ceiling 6e connected to the movable support section 6b, right and left side surfaces 6f, and a bottom insertion section 6g. As shown in FIG. 12, the pin terminal 3a which is inserted through the contact section 5c of the terminal 5 is advanced into the clip section 6c via the bottom insertion section 6g with the distal end being located immediately under the ceiling 6e. The right and left side surfaces 6f of the clip section 6c are brought into press contact with the side wall 5r of the contact section 5c from the outside and performs a holding force to clip the pin terminal 3a via the side wall 5r.

The above described clip terminal 6 is held in a floating state in which the movable support section 6b and the clip section 6c except for the fixing piece 6a are not in contact with the inner wall of the fitting chamber 9 of the housing 4. Accordingly, the clip terminal 6 is displaceable without being disturbed by the inner wall of the fitting chamber 9. However, since the clip section 6 clips the side surface 5r of the contact section 5c, it is displaceable following the displacement of the contact section 5c.

### Assembly Method of Connector 1

In the above connector 1, the clip terminals 6 are inserted into the respective fitting chambers 9 from the front side of the housing 4 so that the fixing piece 6a is inserted into the fixing section 13. Further, the respective terminals 5 are inserted into the corresponding housing recesses 11 from the back side of the housing 4. Specifically, the contact section 5c of the terminal 5 is inserted into the fitting chamber 9 through the movable groove 18 and the communication hole 12 so that it is held between the right and left side walls 6f of the clip terminal 6. At the same time, the press fitting piece 5e of the terminal 5 is press fitted into the press fitting section 17 of the housing recess 11 of the housing 4 and fixed thereto. Thus, the connector 1 can be assembled. Whether the terminal 5 or the clip terminal 6 is first assembled to the housing 4 is not specifically limited.

### Usage of Connector 1

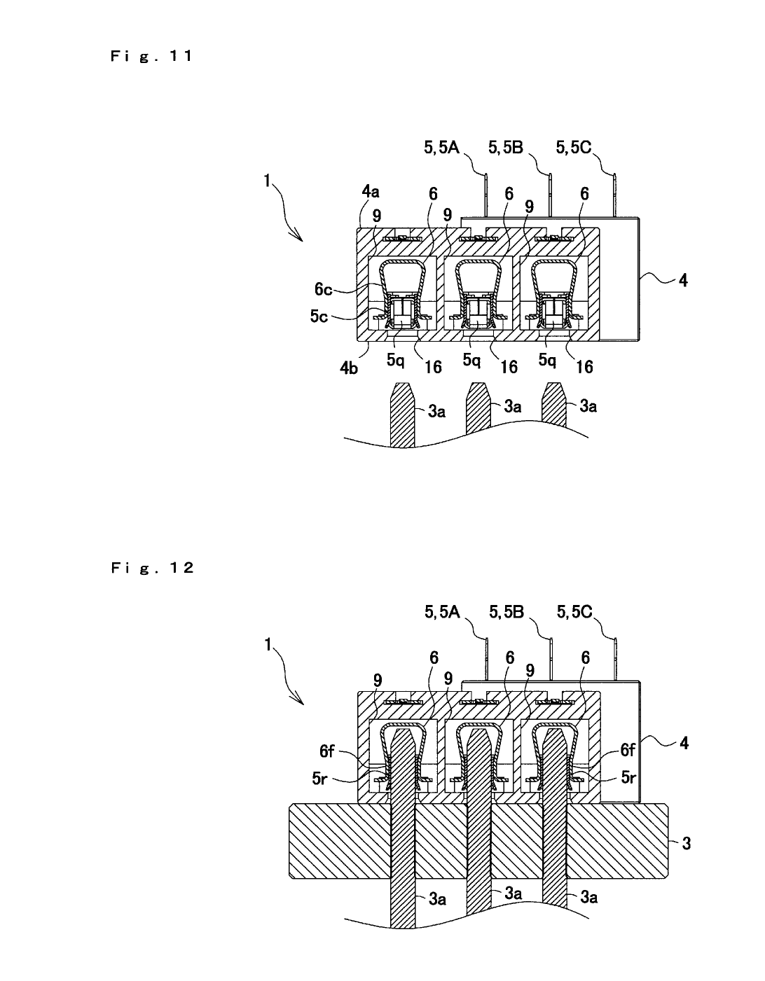

As indicated by the two-dotted dashed line in FIG. 2, the connector 1 is fixed with the base connections 5d inserted into the through holes of the printed circuit board 2 and soldered thereto. As shown in FIGS. 11 and 12, the pin terminals 3a of the counterpart connector 3 are inserted from the underside of the connector 1 through the insertion holes 16 on the lower wall 4b of the housing 4.

When the axis of the pin terminal 3a is aligned with the hole axis of the lower contact hole 5n of the contact section 5c of the terminal 5 during insertion, the contact section 5c receives the pin terminal 3a at an initial position without being displaced in the right and left direction X and the front and back direction Y. However, when the axis of the pin terminal 3a is not aligned with the hole axis of the lower contact hole 5n during insertion, the contact section 5c is displaced in the right and left direction X and the front and back direction Y so that the hole axis of the lower contact hole 5n is aligned with the axis of the pin terminal 3a, thereby absorbing the positional deviation of the pin terminal 3a. This operation of the terminal 5 is independently performed for each of the terminals 5A, 5B, 5C which correspond to the respective pin terminals 3a. Accordingly, in the connector 1, the contact section 5c is each displaced depending on the positional deviation of each of the pin terminals 3a, thereby achieving reliable conductive connection for each of the terminals 5A, 5B, 5C.

Further, when the pin terminal 3a is displaced in the right and left direction X and the front and back direction Y due to the counterpart connector 3 being displaced while being in conductive contact with the connector 1, the contact section 5c and the clip section 6c elastically supported in a floating state in the fitting chamber 9 are displaced following the displacement of the counterpart connector 3. That is, the contact section 5c is displaced due to the displacement and deformation of the movable spring section 5b, while the clip section 6c is displaced due to elastic deformation of the movable support section 6b. Accordingly, the connector 1 can maintain a stable conductive contact even if the counterpart connector 3 is displaced.

During insertion of the pin terminals 3a or when the pin terminals 3a are displaced due to displacement of the counterpart connector 3 after connection as described above, the contact section 5c can also be displaced in the up and down direction Z. The contact section 5c is displaced until the protrusion 5k is engaged with the socket 15 from the underside. Further, the displacement in the up and down direction Z is also effective for absorption of thermal contraction after sealing in the case where the pin terminals 3a of the counterpart connector 3 are hermetic seal terminals.

When the contact section 5c, which is in conductive contact with the pin terminal 3a as described above, is in contact with and holds the pin terminal 3a at one point in the longitudinal direction of the pin terminal 3a, the pin terminal 3a may be displaced while being rotated and inclined about the contact position. Accordingly, the pin terminal 3a fails to remain in the standing position, leading to failure in a stable conductive contact with the contact section 5c. However, the contact section 5c of this embodiment has two contact points in the longitudinal direction of the pin terminal 3a, that is, the lower contact hole 5n and the upper contact hole 5p, and in addition to that, the side wall 5r abuts and supports the side surface of the pin terminal 3a in the longitudinal direction. Accordingly, the pin terminal 3a is held in the standing position, thereby ensuring a stable conductive contact.

As described above, even if the contact section 5c and the clip section 6c are displaced following the displacement of the pin terminal 3a, the right and left side surfaces 6f of the clip section 6c are in press contact with the side wall 5r of the contact section 5c from the outside and apply a holding force so as to clip the pin terminal 3a. As a result, the pin terminal 3a is prevented from falling off from the contact section 5c, thereby ensuring a stable conductive contact in a reliable manner.

### Variation of Embodiment

Although three terminals 5 are provided in the above embodiment, any number of the terminals 5 may be used as long as it is more than one. Further, although the terminals 5 are described as having different configurations of the movable spring sections 5b, they may have the same shape.

Although the side surface 5r of the contact section 5c is clipped by the clip section 6c of the clip terminal 6 in the above embodiment, the pin terminal 3a of the counterpart connector 3 may be directly clipped.

What is claimed is:

1. A connector comprising:
a terminal that is configured to be in conductive contact with a pin terminal of a connection target;
a housing which includes a fitting chamber that is configured to be in conductive contact with the pin terminal and the terminal, the terminal including a contact section that comes into contact with the pin terminal and a movable spring section that elastically supports the contact section to be displaceable in the fitting chamber; and
a clip terminal which is displaceable following the displacement of the contact section while holding the pin terminal that is in contact with the contact section in the fitting chamber.

2. The connector according to either claim 1, further comprising a plurality of the terminals, wherein the contact sections of the terminals are independently displaceable while being elastically supported by the movable spring section.

3. The connector according to claim 1, wherein the movable spring section is flexibly deformed so that the contact section is displaced in a direction which intersects with an axis of the pin terminal.

4. The connector according to claim 1, wherein the movable spring section is flexibly deformed so that the contact section is displaced in an axis direction of the pin terminal.

5. The connector according to claim 1, wherein the clip terminal includes a fixing section fixed to the housing, a clip section that holds the pin terminal, and a movable supporting section that supports the clip section to the fixing section to be elastically displaceable in the fitting chamber while connecting the fixing section and the clip section.
